(19) United States
(12) Patent Application Publication
(10) Pub. No.: US 2021/0166174 A1
(43) Pub. Date: Jun. 3, 2021

(54) INFORMATION PROCESSING DEVICE, INFORMATION PROCESSING SYSTEM, METHOD OF PROCESSING INFORMATION, AND NON-TRANSITORY COMPUTER-READABLE STORAGE MEDIUM

(71) Applicant: Ryosuke MIZUNASHI, Kanagawa (JP)

(72) Inventor: Ryosuke MIZUNASHI, Kanagawa (JP)

(73) Assignee: Ricoh Company, Ltd., Tokyo (JP)

(21) Appl. No.: 17/063,778

(22) Filed: Oct. 6, 2020

(30) Foreign Application Priority Data
Nov. 29, 2019 (JP) 2019-217347

(51) Int. Cl. G06Q 10/06; G06Q 10/10; G05B 19/406

(52) U.S. Cl. CPC G06Q 10/06312; G06Q 50/04; G05B 19/406; G06Q 10/103

(57) ABSTRACT

An information processing device includes circuitry. The circuitry extracts input items from operation plan information and receive sensor data indicating operation progress. The sensor data is added with data used for determining an operation type. The circuitry further detects an input item from the extracted input items based on the data added to the sensor data, and inputs the sensor data to the detected input item.

### CROSS-REFERENCE TO RELATED APPLICATION

This patent application is based on and claims priority pursuant to 35 U.S.C. § 119(a) to Japanese Patent Application No. 2019-217347, filed on Nov. 29, 2019, in the Japan Patent Office, the entire disclosure of which is hereby incorporated by reference herein.

### BACKGROUND

### Technical Field

Embodiments of the present disclosure relate to an information processing device, an information processing system, a method of processing information, and a non-transitory computer-readable medium.

### Related Art

There is a known information processing system that uses Internet of Things (IoT). Such an information processing system using IoT is capable of visualizing and managing a work status of workers or a production status of products by converting information related to work of the workers or production of the products into data by using a sensor.

Further, there is a technique of data management in which a key character string is included in a file name of data to be transferred, in order to classify the data, for example, into works or products and thereby the data is manageable.

### SUMMARY

An exemplary embodiment of the present disclosure includes an information processing device. The information processing device includes circuitry. The circuitry extracts input items from operation plan information and receive sensor data indicating operation progress. The sensor data is added with data used for determining an operation type. The circuitry further detects an input item from the extracted input items based on the data added to the sensor data, and inputs the sensor data to the detected input item.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a block diagram illustrating an example of a configuration of an information processing system according to at least one embodiment of the disclosure;

FIG. 2 is a block diagram illustrating a hardware configuration of an input device included in an information processing system according to at least one embodiment of the disclosure;

FIG. 3 is a block diagram illustrating a hardware configuration of an information processing device included in an information processing system according to at least one embodiment of the disclosure;

FIG. 4 is a flowchart illustrating an example of a flow of a system operation performed by an information processing system according to at least one embodiment of the disclosure; and

FIG. 5 is a diagram illustrating an example of a data input form in an information processing system according to at least one embodiment of the disclosure.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

Hereinafter, a detailed description is given of an information processing system according to an embodiment of the disclosure with reference to drawings.

System Configuration

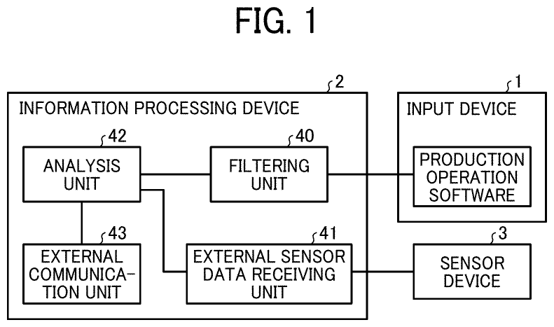

FIG. 1 is a block diagram illustrating an example of a configuration of an information processing system, according to an embodiment. As illustrated in FIG. 1, the information processing system according to the present embodiment includes an input device 1, information processing device 2, and a sensor device 3.

As an example of the input device 1, a personal computer device may be used. As another example of the input device 1, a server device on a network, so-called “cloud”, may be used. The input device 1 may be connected to the information processing device 2 via a data cable or may be connected to the information processing device 2 through a private network such as a Local Area Network (LAN) or a wide area network such as the Internet.

As an example of the information processing device 2, a personal computer device may be used. The information processing device 2 extracts a predetermined input item based on, for example, production operation information (production schedule information) input from the input device 1, and automatically inputs data with respect to the extracted input items based on output data (sensor output, sensor data) from the sensor device 3. A detailed description is given later. This reduces a load of a worker to input data and this visualizes a production status, a work status, or the like. In addition, useful data may be collected and used for later analysis.

As an example of the sensor device 3, an optical sensor, a contact sensor, a load sensor, or the like may be used. For example, the sensor device 3 detects, as a sensor output, a product transferred by a belt conveyor by a detection method, such as a non-contact method or a contact method, and transmits the sensor output (sensor value) together with production date and time information to the information processing device 2. The information processing device 2 performs automatic data input based on the sensor output, which is obtained from the sensor device 3. The detailed description of the automatic data input is given later.

Hardware Configuration of Input Device

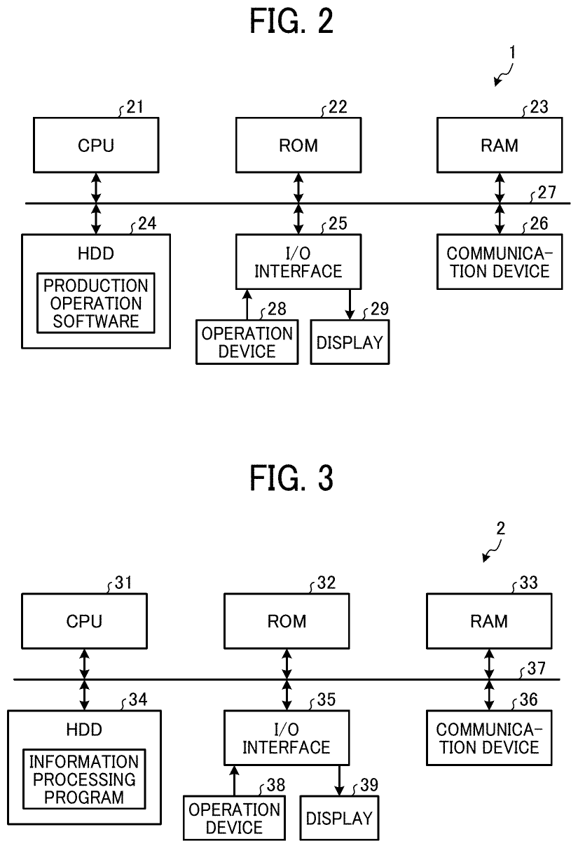

FIG. 2 is a block diagram illustrating a hardware configuration of the input device 1, according to the present embodiment of the disclosure. As illustrated in FIG. 2, the input device 1 includes a central processing unit (CPU) 21, a read only memory (ROM) 22, a random access memory (RAM) 23, a hard disk drive (HDD) 24, an input/output (I/O) interface 25, and a communication device 26. The above-mentioned hardware components, which includes the CPU 21 to the communication device 26, are connected to each other through a bus line 27. To the I/O interface 25, an operation device 28 such as a keyboard device or a mouse device is connected, for example. In addition, a display 29 is connected to the I/O interface 25.

In the HDD 24, production operation software (a production operation software application) is stored. An administrator activates the production operation software and inputs, via the operation device 28, production plan information, such as for example items of, “start time”, “setup time”, “completion time”, “lot number”, “planned quantity”, “model name” and “total actual quantity”. Hereinafter, the production plan information may be referred to as operation plan information in the disclosure. “Start time” is a time to start producing products (production) or to start working (operations). “Setup time” is a period of time that is used to prepare for starting production of products or starting working (operations). A time at which an amount of time of the setup time has just passed from the start time is an actual time to start producing products or start working (operations). “Planned quantity” is a quantity (the number) of products that is planned to be produced. “Total actual quantity” is a total number of products that actually have been produced (completed to be produced). Such production plan information, or operation plan information is transmitted to the information processing device 2 via the communication device 26.

When the input device 1 is a server device that is provided on a predetermined network, an administrator or a worker accesses the server device on the network and inputs the production plan information using the production operation software. The predetermined network is an example of a network set for a specific group such as a company, an organization, or the like so that the network is accessible by group members who are authorized to access. The production plan information is temporarily stored in the server device and then transmitted to the information processing device 2 at a predetermined time, for example, such as a time before the start time of the production.

Hardware Configuration of Information Processing Device

FIG. 3 is a block diagram illustrating a hardware configuration of the information processing device 2, according to an embodiment of the disclosure. As illustrated in FIG. 3, the information processing device 2 includes a CPU 31, a ROM 32, a RAM 33, an HDD 34, an I/O interface 35, and a communication device 36. The above-mentioned hardware components, which includes the CPU 31 to the communication device 36, are connected to each other through a bus line 37. To the I/O interface 35, an operation device 38 such as a keyboard device or a mouse device is connected, for example. In addition, a display 39 is connected to the I/O interface 35.

The HDD 34 stores an information processing program that enables automatic data input with respect to predetermined items (predetermined input items) extracted from the production plan information. The CPU 31 executes the information processing program to implement functions of a filtering unit 40, an external sensor data receiving unit 41, an analysis unit 42, and an external communication unit 43, which are illustrated in FIG. 1.

The filtering unit 40 extracts (filters) the predetermined input items from the production plan information, which is input from the input device 1. The external sensor data receiving unit 41 is an example of a receiving unit (receiver) and receives a sensor output (sensor value, sensor data) transmitted from the sensor device 3 together with production date and time information. The analysis unit 42 is an example of an input unit and automatically performs data input processing (automatic data input) with respect to each extracted item to generate an “operation management table” indicating an actual production result (record) or a work (operation) performance (record). Further, the analysis unit 42 detects an “operation delay” as described later.

The external communication unit 43 displays the “operation management table” generated by the analysis unit 42 on the display 39. Alternatively, the external communication unit 43 transmits the “operation management table” generated by the analysis unit 42 to a server device on a predetermined network. In this case, the administrator or the like downloads the “operation management table” from the server device and manages the operation (work) status or production status. Furthermore, when detecting an “operation delay”, the external communication unit 43 causes the display 39 to display a notification of the delay in the operation progress. The detailed description is given later. Alternatively, when detecting an “operation delay”, the external communication unit 43 reports the delay in the operation progress to one or more devices specified by the administrator in advance. Examples of the devices to be reported include a server device, a personal computer, or a smartphone, which is specified in advance by the administrator.

In the present embodiment, the above-mentioned units of the information processing device 2, which includes the filtering unit 40 to the external communication unit 43, are implemented by executing software, however, a part of (one or more) or all of the above-described units of the information processing device 2 may be implemented by hardware such as an integrated circuit (IC).

In some embodiments, the information processing program may be stored in a computer-readable storage medium such as a compact disc read only memory (CD-ROM) and a flexible disk (FD), in an installable or executable file format, for distribution. In some embodiments, the information processing program may be stored in a computer-readable storage medium such as a compact disc-recordable (CD-R), a digital versatile disk (DVD), a Blu-ray Disc (registered trademark), and a semiconductor memory, for distribution. In some embodiments, the information processing program may be installed through a network such as the Internet or may be provided as being preloaded in a ROM, etc., of the apparatus.

Automatic Generation of Operation Management Table

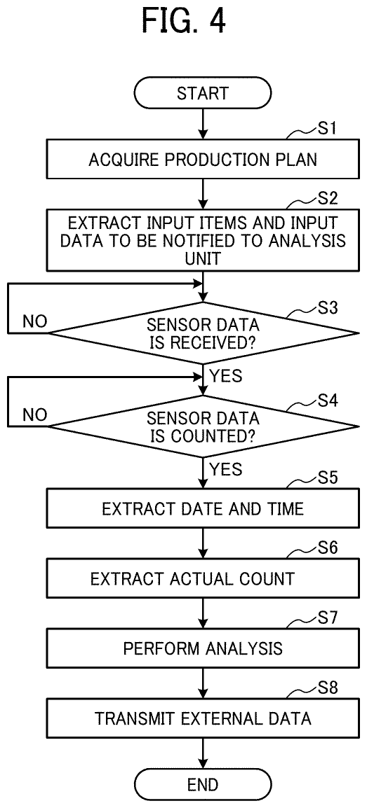

A description is given below of a process of automatically generating an operation management table with reference to FIG. 4. FIG. 4 is a flowchart illustrating an example of a process of automatically generating an operation management table, according to the present embodiment. First, the filtering unit 40 of the information processing device 2 acquires production plan information that is input based on the production operation software of the input device 1 (step S1). Then, the filtering unit 40 extracts (filters) predetermined input items and input data from the acquired production plan information. Then, the filtering unit 40 supplies the extracted information to the analysis unit 42 (step S2).

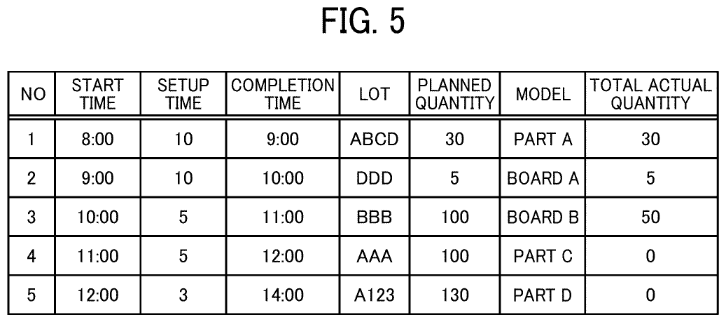

FIG. 5 is a diagram illustrating an example of the operation management table. The filtering unit 40 extracts, from the production plan information, the input items (predetermined input items) required to generate the operation management table as illustrated in FIG. 5. The input items are, for example, items of start time, setup time, completion time, lot number, planned quantity, model, and total actual quantity for the operation. Then the filtering unit 40 supplies the extracted input items to the analysis unit 42. Further, the filtering unit 40 extracts from the production plan information the input data, which is determined at a step of production planning, such as input data of start time, setup time, completion time, lot number, planned quantity, and model, and then supplies the input data to the analysis unit 42.

That is, the example of the operation management table illustrated in FIG. 5 is an example in which a type of parts or boards to be produced and a corresponding planned quantity to be produced are determined for each time zone. Specifically, in the example illustrated in FIG. 5, 30 parts A are planned to be produced in the time zone from 8:00 to 9:00, 5 boards A are planned to be produced in the time zone from 9:00 to 10:00, and 100 boards A are planned to be produced in the time zone from 10:00 to 11:00. In addition, in the example illustrated in FIG. 5, 100 parts C are planned to be produced in the time zone from 11:00 to 12:00, and 130 parts D are planned to be produced in the time zone from 12:00 to 14:00.

The “setup time” is a period of time required to set a production line, to switch materials or equipment, or the like, before starting producing a type of products. In the example of FIG. 5, the setup time required for producing the part A is 10 minutes. Accordingly, in the time of producing the part A (starting time to completion time), which is from 9:00 and 10:00, the time from 9:00 to 9:10 is used for setting the production line, switching of materials or equipment, or the like, and thereby the part A is actually produced between 9:10 and 10:00.

Similarly, in a period of time to produce a part D (starting time to completion time), which is from 12:00 and 14:00, a period of time from 12:00 to 12:03 is used for setting the production line, switching of materials or equipment, or the like, and the part D is actually produced between 12:03 and 14:00.

Referring to FIG. 4, in step S3, the external sensor data receiving unit 41 determines whether sensor data that indicates production of a product, is supplied, or received, from the sensor device 3. For example, when a produced product passes through in front of the sensor device 3, the sensor data, which indicates the production of the product, is supplied from the sensor device 3 to the external sensor data receiving unit 41 of the information processing device 2 (step S3: Yes).

The sensor device 3 supplies status data of the production line indicating one of the various statuses including being pending, being in preparation (during setup time), and being in operation (operating normally), to the external sensor data receiving unit 41 together with the sensor data. The production line may be referred to as an operation line in the disclosure. In step S4, the external sensor data receiving unit 41 determines whether to count the sensor data based on the status data.

That is, the sensor data that is generated when the production line is stopped (pending) or in preparation (during setup time) is not generated based on the fact that the product is actually produced. Accordingly, counting such sensor data as one of the products being produced is meaningless (step S4: No). Accordingly, the external sensor data receiving unit 41 counts the sensor data obtained from the sensor device 3 when the sensor data is added with the status data that indicates that the production line is in operation (operating normally) (step S4: Yes).

In the embodiment described above, the sensor device 3 supplies the status data. In another embodiment, in alternative to the sensor device 3, other device that manages the production line or a personal computer that belongs to the administrator may supply the status data, for example.

Further, the sensor data output from the sensor device 3 is added with the date and time information (production data and time information) indicating a date and time when the product is produced (namely, date and time information indicates the date and time when the sensor data is generated). The external sensor data receiving unit 41 extracts the date and time information, which is added to the received sensor data (step S5). In addition, the external sensor data receiving unit 41 detects a counted number of produced products that is indicated by the received sensor data (step S6). Hereinafter, information on the counted number of produced products may be referred to as product count information. Then, the external sensor data receiving unit 41 supplies the extracted date and time information and the product count information indicating the counted number of produced products to the analysis unit 42.

The analysis unit 42 refers to the operation management table illustrated in FIG. 5 and determines a model that is currently produced, based on the date and time information supplied from the external sensor data receiving unit 41. That is, the date and time information added to the sensor data is data used for determining an operation type (a type of operation). For example, when the date and time information supplied from the external sensor data receiving unit 41 is “8:30”, the part A is currently produced. In addition, the product count information supplied from the external sensor data receiving unit 41 indicates the number of parts A actually produced. Accordingly, the analysis unit 42 increments, by “one”, a numerical value of an input item of the total actual quantity of the part A in the operation management table.

Similarly, when the date and time information supplied from the external sensor data receiving unit 41 is “10:50”, the board B is currently produced. In addition, the product count information supplied from the external sensor data receiving unit 41 indicates the number of boards B produced. Accordingly, the analysis unit 42 increments a numerical value of the input item (an example of a corresponding input item) of the total actual quantity of the board B in the operation management table by “one”.

Such input operation related to the total actual quantity is continuously performed until the total actual quantity reaches the planned quantity. That is, the analysis unit 42 increments (inputs) the total actual quantity one by one and counts the number of products until the planned quantity of products is produced (step S7 and step S8).

The example of FIG. 5 indicates that the board B is currently produced in the time zone between 10:05 to 11:00, and production of 50 boards has been completed out of the 100 boards that are planned to be produced. Each time the production of one board B is completed, the analysis unit 42 increments the numerical value of the input item of total actual quantity by one, such as 51 boards, 52 boards, 53 boards . . . and 100 boards.

Accordingly, the operation management table in which each of the input items and the quantity of products (total actual quantity) are automatically input is generated.

Process of Generating Dynamic Content

Further, the analysis unit 42 may generate dynamic content such as a bar graph extending by a predetermined amount each time when the total actual quantity is incremented by one, for example. As a result, the content that facilitate a user to visually recognize the progress of production is provided.

Delay Notification

By dividing, by the total actual quantity, a time that is obtained subtracting the setup time from an amount of time from the start time to a current time, an actual production time that is required to actually produce one product is calculated. In addition, by multiplying the actual production time and the planned quantity (the number of planned products to be produced), a time that is required to complete the production of the planned quantity of the product is obtainable. The time obtained based on the calculation is referred to as a production completion time. Then, by comparing the production completion time with a period of time from the actual time to start producing products or start working (operations) to the completion time, progress of the production of the products is recognizable.

For example, it is assumed that 25 minutes have passed since the production of the parts A started. In addition, the total actual quantity of the parts A at this time is 15. The original plan is to produce 30 parts A in 50 minutes. Accordingly, when 25 minutes have passed since the production started, the total actual quantity is 15. This means that the part A is produced as originally planned.

On the other hand, for example it is assumed that 25 minutes have passed since the production of the parts A started. In addition, the total actual quantity of the parts A at this time is 10. The original plan is to produce 30 parts A in 50 minutes, but when 25 minutes have passed since the production started, the total actual quantity is 10. This indicates that the production is later than planned.

When detecting such a production delay (operation delay) by performing the calculation described above, the analysis unit 42 generates a “delay notification” to be supplied to the external communication unit 43.

The external communication unit 43 displays the operation management table and the dynamic content generated by the analysis unit 42 on the display 39. The operation management table and the dynamic content are updated in real time. This allows the administrator or the like to check that the value of the total actual quantity is incremented one by one and the total actual quantity gradually approaches the planned quantity, via the display 39.

When the external communication unit 43 receives the “delay notification” from the analysis unit 42 due to the delay in the production (operation progress), the external communication unit 43 displays the delay notification on the display 39. As a result, the administrator or the like may recognize the delay occurring in the production line and may take an action such as increasing the production speed, for example.

In the embodiment described above, the operation management table, the dynamic content, and the delay notification are displayed on the display 39 of the information processing device 2. In some embodiments, the operation management table, the dynamic content, and the delay notification may be uploaded to a server device on a predetermined network. In this case, the administrator or the like manages the production status or the like by downloading the operation management table and the delay notification uploaded to the server device. In some embodiments, the operation management table and delay notification may be sent to a smartphone or a personal computer device used by the administrator, for example. In some embodiments, the operation management table, the dynamic content, and/or the delay notification are displayed on the display 39 of the information processing device 2, are uploaded to a server device on a predetermined network, and/or are sent to a smartphone or a personal computer device used by the administrator, for example.

As described above, in the information processing system according to the present embodiment, the information processing device 2 extracts the input items of the operation management table based on the production plan information that is input via the input device 1. The information processing device 2 increments the value of the total actual quantity in the operation management table one by one each time the sensor device 3 detects the production of one product. The external communication unit 43 displays the operation management table on the display 39. Accordingly, the data corresponding to each input item is displayed as the operation management table generated by automatic input without burdensome work.

Further, the analysis unit 42 monitors the production progress of the product and generates a “delay notification” when the production is delayed. Then, the external communication unit 43 displays the “delay notification” on the display 39. As a result, the administrator or the like may recognize the delay occurring in the production line and may take an action such as increasing the production speed, for example.

In a conventional information processing system, it is difficult to automatically determine a destination to input data and input the data, for each type of data acquired by a sensor. Accordingly, in such a conventional information processing system, a worker determines the destination and inputs the data to the destination after the data is acquired. Due to this, in the conventional information processing system, time and work is required to input data.

In addition, in order to automatically classify and manage the data, a file name of the data, which is to be transferred, is required to include a key character string. Due to this, a large number of key character strings is required to be prepared in advance, resulting in burdensome work.

The disclosure has been made in view of the above-described issue, and an object of an embodiment is to provide an information processing device, a method of processing information, an information processing program, and an information processing system capable of inputting data without burdensome work.

According to an embodiment of the present disclosure, data is input without burdensome some work.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

What is claimed is:

1. An information processing device, comprising circuitry configured to
extract input items from operation plan information,
receive sensor data indicating operation progress, the sensor data being added with data used for determining an operation type,
detect an input item from the extracted input items based on the data added to the sensor data, and
input the sensor data to the detected input item.

2. The information processing device according to claim 1,
wherein the sensor data is further added with status data indicating an operation status of an operation line, and
wherein the circuitry inputs the sensor data in response to the status data indicating that the operation line is in operation.

3. The information processing device according to claim 1,
wherein the circuitry generates a delay notification when detecting a delay in the operation progress.

4. The information processing device according to claim 1,
wherein the circuitry generates dynamic content dynamically indicating the operation progress.

5. An information processing system, comprising:
the information processing device according to claim 1; and
an input device including input device circuitry configured to
generate the operation plan information, and
provide the operation plan information to the information processing device, and
wherein the circuitry performs at least one of causing a display to display content including the input sensor data, or transmitting the input sensor data to a server device through a predetermined network.

6. The information processing system according to claim 5,
wherein the sensor data is further added with status data indicating an operation status of an operation line, and
wherein the circuitry inputs the sensor data in response to the status data indicating that the operation line is in operation.

7. The information processing system according to claim 5,
wherein the circuitry generates a delay notification when detecting a delay in the operation progress.

8. The information processing system according to claim 5,
wherein the circuitry generates dynamic content dynamically indicating the operation progress.

9. A method of processing information, comprising:
extracting input items from operation plan information;
receiving sensor data indicating operation progress, the sensor data being added with data used for determining an operation type;
detecting an input item from the extracted input items based on the data added to the sensor data; and
inputting the sensor data to the detected input item.

10. The method of processing information according to claim 9,
wherein the sensor data is further added with status data indicating an operation status of an operation line, and
wherein the inputting the sensor data includes inputting the sensor data in response to the status data indicating that the operation line is in operation.

11. The method of processing information according to claim 9, further comprising
generating a delay notification when detecting a delay in the operation progress.

12. The method of processing information according to claim 9, further comprising
generating dynamic content dynamically indicating the operation progress.

13. A non-transitory recording medium storing a plurality of instructions which, when executed by one or more processors, cause the processors to perform a method, comprising:
extracting input items from operation plan information;
receiving sensor data indicating operation progress, the sensor data being added with data used for determining an operation type;
detecting an input item from the extracted input items based on the data added to the sensor data; and
inputting the sensor data to the detected input item.
